(19) United States
(12) Patent Application Publication
(10) Pub. No.: US 2026/0155684 A1
(43) Pub. Date: Jun. 4, 2026

(54) PROGRESSIVE CAVITY ASSEMBLY AND ASSOCIATED METHODS

(71) Applicant: THRU TUBING SOLUTIONS, INC., NEWCASTLE, OK (US)

(72) Inventors: Roger L. SCHULTZ, Ninnekah, OK (US); Gary P. FUNKHOUSER, Moore, OK (US)

(21) Appl. No.: 19/344,010

(22) Filed: Sep. 29, 2025

Related U.S. Application Data
(63) Continuation-in-part of application No. 18/817,784, filed on Aug. 28, 2024.
(63) Continuation-in-part of application No. 18/935,723, filed on Nov. 4, 2024.
(63) Continuation-in-part of application No. 19/313,527, filed on Aug. 28, 2025.

(51) Int. Cl. H02K 1/12; H02K 1/22; H02K 15/40

(52) U.S. Cl. CPC H02K 1/12; H02K 1/22; H02K 15/40

(57) ABSTRACT

A progressive cavity assembly can include a stator surrounding a rotor, the stator including a tubular housing and a stator section having a helical stator profile formed therein. A material between the stator section and the housing secures the stator section in the housing, and the material abuts a face of the stator section configured to prevent rotation of the stator section relative to the material. A method of producing a progressive cavity assembly can include providing a stator section having a helical stator profile formed therein, positioning the stator section in a tubular housing, centralizing the stator section in the housing, and injecting a material into a gap between an interior surface of the housing and an exterior surface of the stator section, thereby securing the stator section in the housing.

### CROSS-REFERENCE TO RELATED APPLICATIONS

This application is a continuation-in-part of prior U.S. application Ser. No. Ser. No. 18/817,784 filed on 28 Aug. 2024, a continuation-in-part of prior U.S. application Ser. No. 18/935,723 filed on 4 Nov. 2024, and a continuation-in-part of prior U.S. application Ser. No. 19/313,527 filed on 28 Aug. 2025. The entire disclosures of the prior applications are incorporated herein for all purposes.

### BACKGROUND

This disclosure relates generally to equipment utilized and operations performed in fluid flow applications and, in an example described below, more particularly provides a progressive cavity assembly, such as, for a Moineau-type progressive cavity fluid pump or positive displacement fluid motor, and a method.

Fluid motors can be used for a variety of different purposes. In well operations, a fluid motor is commonly connected as part of a drill string deployed into the well. Fluid flow through the drill string produces rotation of a drill bit connected to the fluid motor.

Fluid pumps can be used for a variety of different purposes. A progressive cavity fluid pump generally includes a rotor and a stator, each having helical lobes, but with different numbers of lobes for the rotor and the stator.

Production of a progressive cavity assembly can be a complex, expensive and time-consuming process. It will, therefore, be readily appreciated that advancements are continually needed in the art of designing, constructing and utilizing progressive cavity assemblies. The present disclosure provides such advancements to the art, which may be used with a wide variety of different types of operations.

### BRIEF DESCRIPTION OF THE DRAWINGS

FIG. 1 is a representative partially cross-sectional view of an example of a well system and associated method which can embody principles of this disclosure.

FIG. 2 is a representative cross-sectional view of an example of a downhole fluid motor that may be used in the FIG. 1 system and method.

FIG. 3 is a representative partially cross-sectional perspective view of an example of an assembly of stator sections that may be used in the FIG. 2 fluid motor.

FIG. 4 is a representative partially cross-sectional perspective view of an end of the FIG. 3 assembly of stator sections.

FIG. 5 is a representative cross-sectional view of an example of a stator section.

FIG. 6 is a representative cross-sectional view of an example of a stator.

FIG. 7 is a representative partially cross-sectional perspective view of an end of the stator.

FIG. 8 is a representative cross-sectional view of an example of a housing deformation tool for use with the stator.

FIG. 9 is a representative cross-sectional view of another example of the stator in the housing deformation tool.

FIG. 10 is a representative cross-sectional view of another example of the stator.

FIG. 11 is a representative cross-sectional view of another example of the stator with a lining being formed in the stator.

FIG. 12 is a representative flow chart for an example method of producing the stator.

FIG. 13 is a representative and schematic view of a fluid pump that embodies the principles of this disclosure.

FIG. 14 is a representative perspective and partially cross-sectional view of another example of the stator section.

FIG. 15 is a representative perspective and partially cross-sectional view of another example of the stator.

FIG. 16 is a representative cross-sectional view of another example of the stator.

FIG. 17 is a representative perspective view of an example of a stator section assembly.

FIG. 18 is a representative perspective view of an end of the FIG. 17 stator section assembly.

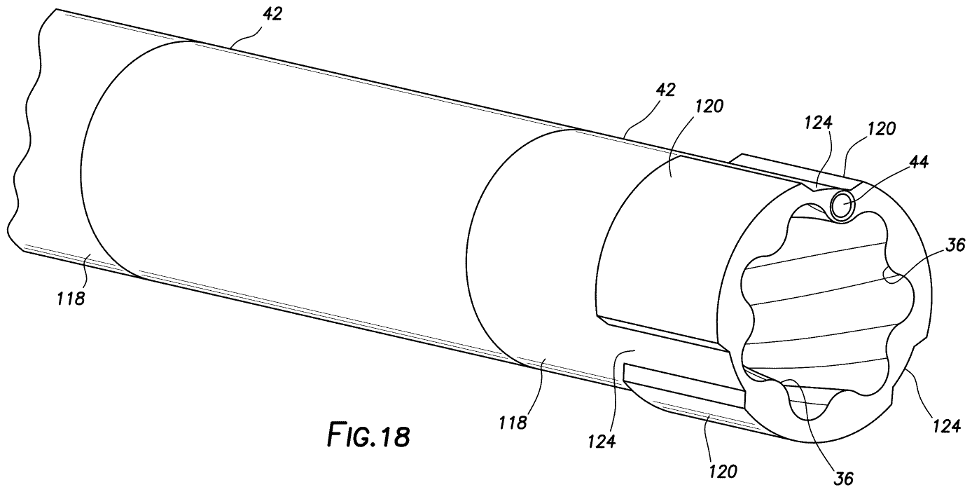

FIG. 19 is a representative perspective view of another example stator section.

FIG. 20 is a representative perspective view of another example stator section.

FIG. 21 is a representative perspective view of an assembly of the FIG. 20 stator sections.

FIG. 22 is a representative cross-sectional view of an example of the stator comprising the FIG. 21 stator section assembly.

### DETAILED DESCRIPTION

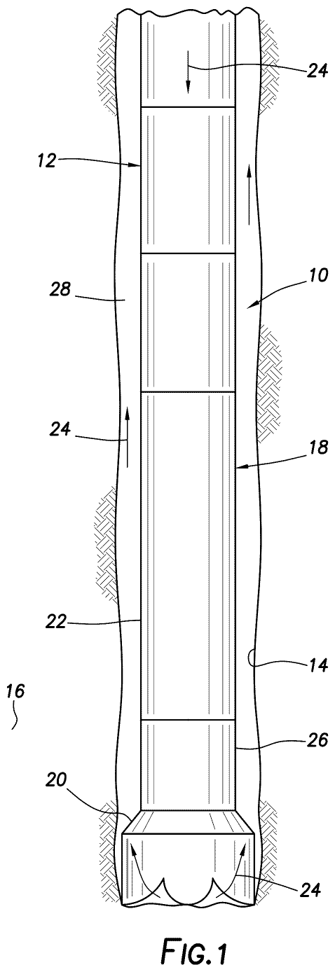

Representatively illustrated in FIG. 1 is a system 10 for use with a subterranean well, and an associated method, which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a tubular string 12 is being used to drill a wellbore 14 into an earth formation 16. For this purpose, a bottom hole assembly 18 including a drill bit 20 is connected at a distal end of the tubular string 12.

To rotate the drill bit 20, the bottom hole assembly 18 includes a downhole fluid motor 22 (such as, a Moineau-type positive displacement motor). The fluid motor 22 is driven by fluid flow 24 through the tubular string 12. In the FIG. 1 example, the fluid flow 24 passes through the tubular string 12, including the fluid motor 22. The fluid flow 24 produces rotation of a rotor in the fluid motor 22. This rotation is transmitted via a bearing assembly 26 to the drill bit 20.

The fluid flow 24 exits the tubular string 12 via nozzles in the drill bit 20. The fluid flow 24 returns to the surface via an annulus 28 formed radially between the tubular string 12 and the wellbore 14.

In other examples, the fluid motor 22 may be used in well operations other than a drilling operation. For example, the fluid motor 22 could be used in a milling, reaming, completion, abandonment or other type of well operation. Thus, the scope of this disclosure is not limited to any particular details of the FIG. 1 system and method.

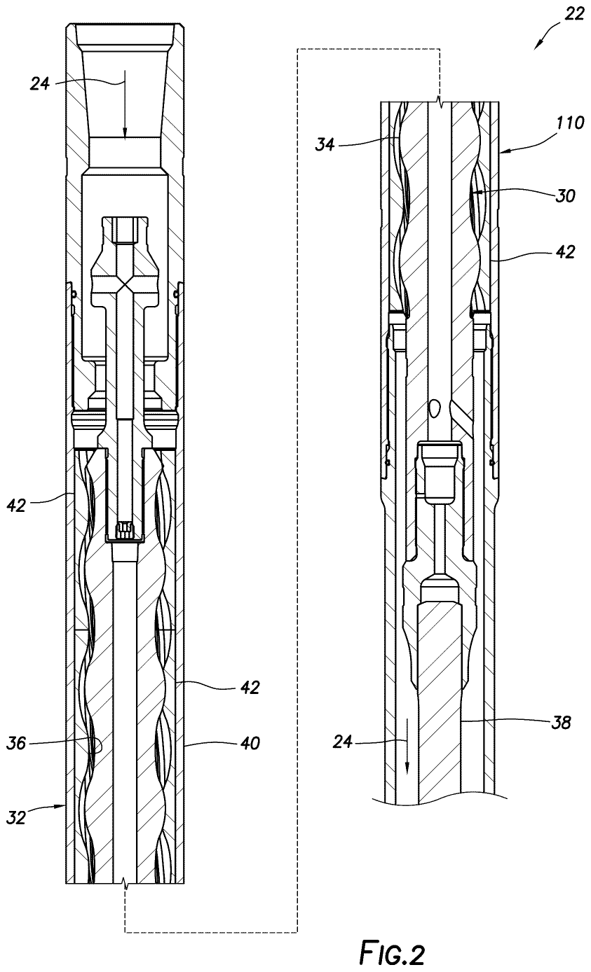

Referring additionally now to FIG. 2, a cross-sectional view of an example of the fluid motor 22 is representatively illustrated. For convenience, the FIG. 2 fluid motor 22 is described below as it may be used in the FIG. 1 system 10 and method. However, the FIG. 2 fluid motor 22 may be used with other systems and methods.

In the FIG. 2 example, the fluid motor 22 includes a rotor 30 received in a stator 32. The rotor 30 has multiple external helical lobes 34 formed thereon which engage a stator profile comprising multiple internal helical lobes 36 formed in the stator 32. The numbers of external and internal lobes 34, 36 are not the same, so that a cavity formed between the external and internal lobes progresses axially between the rotor 30 and stator 32 as the rotor rotates in the stator.

The fluid motor 22 comprises an example of a progressive cavity assembly 110. In this example, the fluid motor 22 is a Moineau-type positive displacement motor. The assembly 110 comprises the rotor 30 and stator 32.

The fluid flow 24 between the rotor 30 and the stator 32 produces rotation of the rotor. This rotation is transmitted via a flexible drive shaft 38 and the bearing assembly 26 (see FIG. 1) to the drill bit 20.

The stator 32 includes an outer housing 40. The internal lobes 36 are formed in axially stacked stator sections 42 received in the housing 40. The stator sections 42 can be rotationally indexed relative to each other (so that the lobes 36 extend continuously in series through the stator sections) and secured in the housing 40 in a variety of different ways, examples of which are described more fully below.

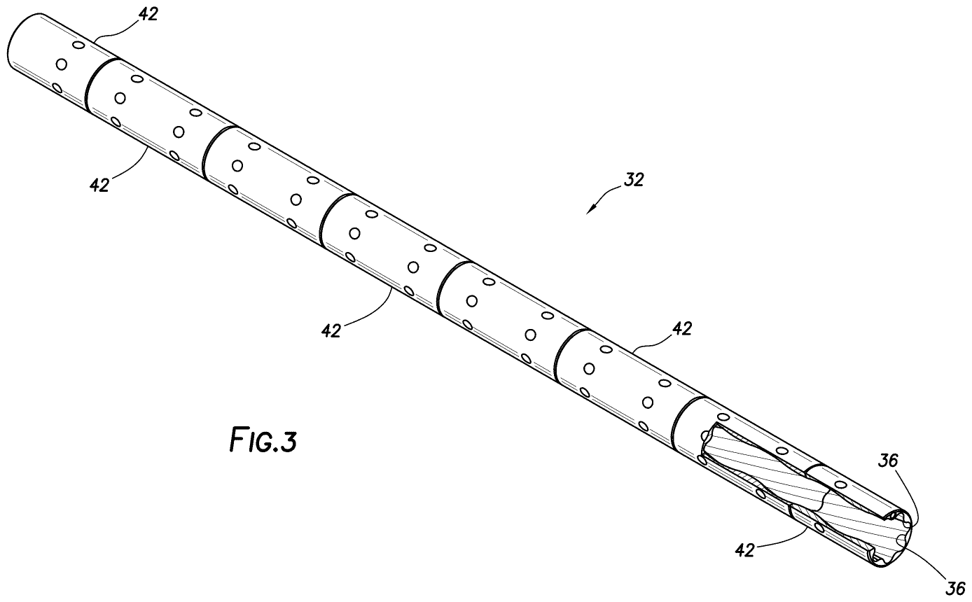

Referring additionally now to FIG. 3, a partially cross-sectional view of an example of the axially stacked stator sections 42 is representatively illustrated. The FIG. 3 stator sections 42 may be used in the FIG. 2 fluid motor 22, or they may be used in other fluid motors, fluid pumps or progressive cavity assemblies. For convenience, the FIG. 3 stator sections 42 are described below as they may be used in the FIG. 2 fluid motor 22.

As depicted in FIG. 3, there are eight of the stator sections 42 in the stator 32. At opposite ends of the stack, the stator sections 42 are not as long as the six stator sections between the ends. In other examples, all of the stator sections 42 may have the same length, or the stator sections may all have different lengths. The scope of this disclosure is not limited to any particular number, lengths, combination of lengths or arrangement of the stator sections 42.

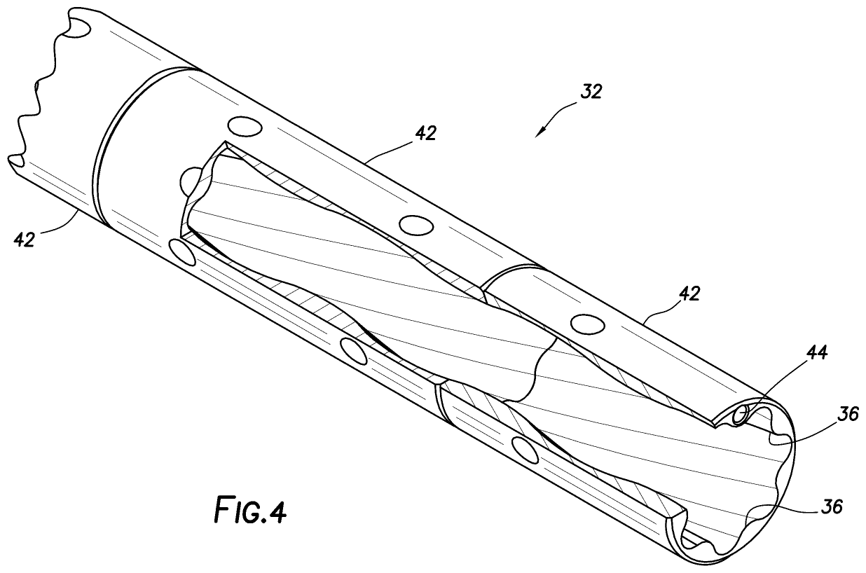

Referring additionally now to FIG. 4, an enlarged view of one end of the stack of stator sections 42 is representatively illustrated. In this view, the manner in which the stator sections 42 are rotationally indexed relative to each other can be more clearly seen. The internal helical lobes 36 are rotationally aligned between adjacent pairs of the stator sections 42, so that the lobes extend continuously through the stack of stator sections.

An opening 44 can extend helically through a lobe 36 of each stator section 42. The openings 44 of adjacent pairs of the stator sections 42 can be rotationally aligned (e.g., due to the rotational indexing of the stator sections), so that the opening extends continuously through the stack of stator sections. The opening 44 may be used as a conduit for conductors, optical fibers, fluid flow or pressure, etc., in the fluid motor 22.

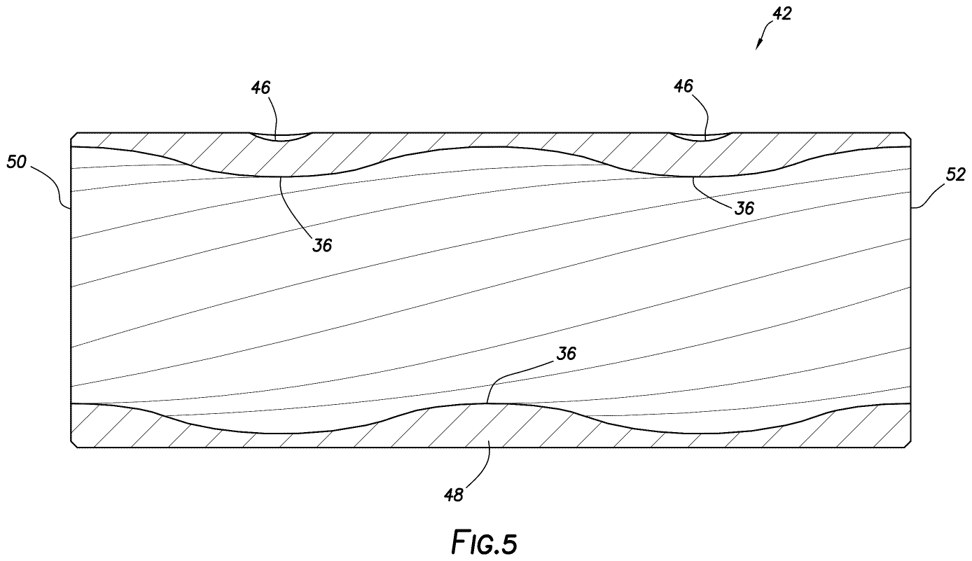

Referring additionally now to FIG. 5, a cross-sectional view of an example of the stator section 42 is representatively illustrated. The FIG. 5 stator section 42 may be used in the FIG. 2 fluid motor, or it may be used with other fluid motors, fluid pumps or progressive cavity assemblies.

In the FIG. 5 example, recesses 46 are formed in an outer surface of the stator section 42. As described more fully below, the recesses 46 can receive protrusions formed in the housing 40, to thereby secure the stator section 42 in the housing and to maintain the rotational indexing between adjacent pairs of stator sections.

As depicted in FIG. 5, the recesses 46 are aligned with the lobes 36, so that the recesses are positioned in relatively thicker portions of the stator section 42. In other examples, the recesses 46 are not necessarily aligned with the lobes 36, the recesses may be used for other purposes, or the recesses may not be formed on the stator section. Any number or arrangement of the recesses 46 may be used.

The stator section 42 is preferably made of a material 48 that is relatively hard and non-elastomeric. Suitable materials include (but are not limited to) metals, cross-linked polymers, etc. The material 48 may be cast, forged, sintered, molded, or produced by electrical discharge machining (EDM), conventional machining, powder metallurgy, or any other suitable technique.

If the rotor 30 and the stator sections 42 are each made of a metal material, then there may be metal-to-metal contact between the internal lobes 36 of the stator sections and the external lobes 34 of the rotor. This metal-to-metal contact can have the benefit of extended useful life of the fluid motor 22. For enhanced sealing between the rotor 30 and the stator sections 42, a lining may be provided on interior surfaces of the lobes 36, as described more fully below.

To achieve and maintain rotational indexing of the stator section 42 with adjacent stator sections, opposite ends 50, 52 of the stator section 42 can have profiles, recesses, protrusions, fasteners or other types of engagement devices. These alignment or engagement devices may be formed on, attached or connected to the stator section 42. In one example, helical grooves could be formed on exterior surfaces of the stator sections 42 (such as, aligned with one of the lobes 36), and a helical member could be installed in the aligned grooves to maintain the rotational alignment of the stator sections.

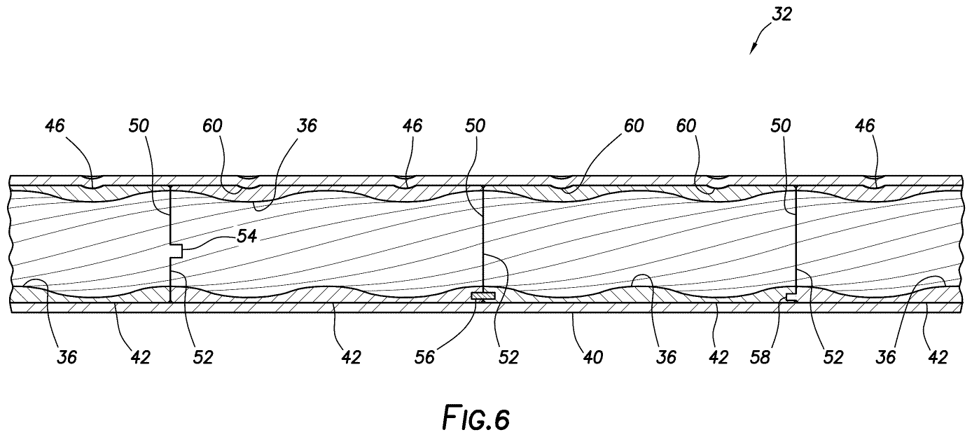

Referring additionally now to FIG. 6, a cross-sectional view of an example of a portion of the stator 32 is representatively illustrated. In the FIG. 6 example, a stack of the stator sections 42 has been installed in the housing 40. Various examples of engagement devices are depicted in FIG. 6 for rotational indexing of the stator sections 42.

In a first device 54, adjacent stator sections 42 are rotationally interlocked by engagement of a tab formed on an end 52 of one of the stator sections with a slot formed on a facing end 50 of the other stator section. In a second device 56, a fastener or pin is received in openings formed in the facing ends 50, 52 of adjacent stator sections 42. In a third device 58, a profile (e.g., in the shape of a protrusion) on one end 50 is engaged with a complementary profile (e.g., in the shape of a recess) on the opposing end 52. However, the devices 54, 56, 58 are merely examples of possible engagement devices, and other types of rotational indexing or rotational alignment devices may be used in other examples.

As depicted in FIG. 6, the stator sections 42 are secured in the housing 40 with protrusions 60 formed on an interior surface of the housing. The protrusions 60 extend into engagement with respective ones of the recesses 46 on the stator sections 42. This engagement prevents relative displacement between the housing 40 and the stator sections 42 in axial and rotational directions. Thus, in examples in which the protrusions 60 are engaged with the recesses 46, this engagement can maintain rotational indexing and alignment between the stator sections 42, so that the engagement devices 54, 56, 58 (or any other rotational indexing or alignment devices) may not be used.

Note that mechanical interference could be provided between the stator sections 42 and the housing 40 in a variety of different ways. For example, use of the recesses 46 is not necessary, since the housing 40 could be deformed into contact with the stator sections 42 to thereby secure the stator sections in the housing. The stator sections 42 could be press-fit or shrink-fit in the housing 40. A helical groove could be formed in the housing 40 for engagement with a helical profile formed on each of the stator sections 42 in another example.

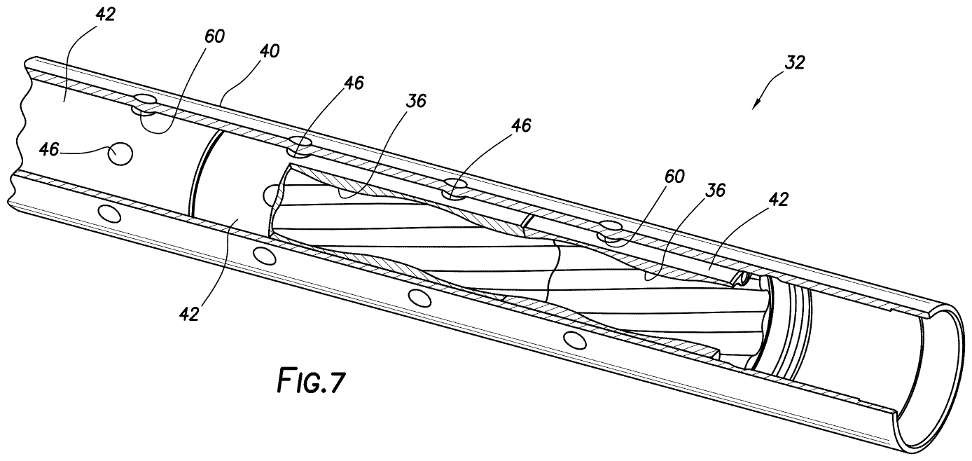

Referring additionally now to FIG. 7, a partially cross-sectional view of another example of the stator 32 is representatively illustrated. In this example, the stator sections 42 are secured in the housing 40 using the protrusions 60 engaged with the recesses 46 on the stator sections. The engagement between the protrusions 60 and the recesses 46 also rotationally indexes and aligns the stator sections 42 relative to each other, and no additional engagement devices are used.

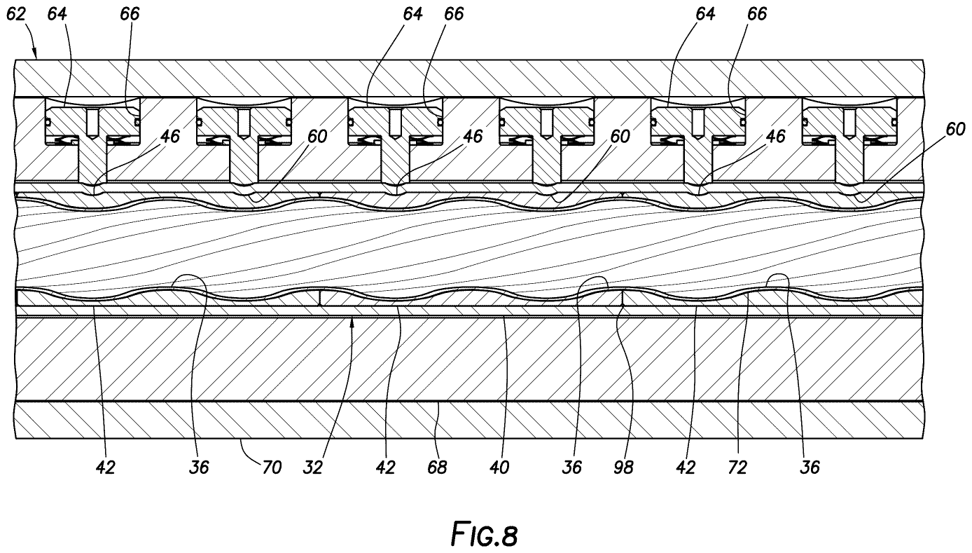

Referring additionally now to FIG. 8, a cross-sectional view of an example of the protrusions 60 being formed in the housing 40 of the stator 32 is representatively illustrated. In this example, the housing 40 with the stack of stator sections 42 therein is inserted into a housing deformation tool 62. The housing 40 is deformed by the tool 62, so that the protrusions 60 are formed on the interior surface of the housing, and the protrusions extend into respective ones of the recesses 46.

The stator sections 42 are rotationally indexed and aligned with each other prior to the housing 40 being deformed. After deformation of the housing 40, the rotational indexing and alignment is maintained by the engagement between the protrusions 60 and the recesses 46.

In the FIG. 8 example, the tool 62 includes multiple pistons 64 received in bores 66 formed in an inner body 68. Pressure applied between the inner body 68 and an outer housing 70 biases the pistons 64 to displace inward toward the housing 40. Sufficient applied pressure will cause the housing 40 to deform inward toward the stator sections 42, so that the protrusions 60 are formed and engage the recesses 46.

The stator sections 42 may be rotationally indexed and aligned with each other before or after they are installed in the housing 40, and before or after they are received in the tool 62. In other examples, other means may be used for rotationally indexing or aligning the stator sections 42, or for securing the stator sections in the housing 40.

For example, the stator sections 42 could be rotationally indexed and aligned with each other (such as, using the engagement devices 54, 56, 58, or using an alignment mandrel inserted into the stator sections), and then the adjacent stator sections could be welded to each other. In another example, the stator sections 42 could be rotationally indexed and aligned with each other, and then the stator sections could be secured to the housing 40 by welding through holes formed through a wall of the housing.

In yet another example, a material 98 (such as, an elastomer, a cement, a polymer, a bonding agent, etc.) could be injected between the housing 40 and the stator sections 42 after the stator sections are rotationally indexed and aligned with each other. When the material 98 cures, the stator sections 42 are thereby secured in the housing 40 and are rotationally indexed and aligned with each other. Thus, the scope of this disclosure is not limited to any particular technique for rotationally indexing and aligning the stator sections 42, or to any particular order of steps (e.g., indexing and aligning the stator sections, installing the stator sections in the housing 40, securing the stator sections to each other and to the housing, etc.), or to any particular technique for securing the stator sections to each other or in the housing 40.

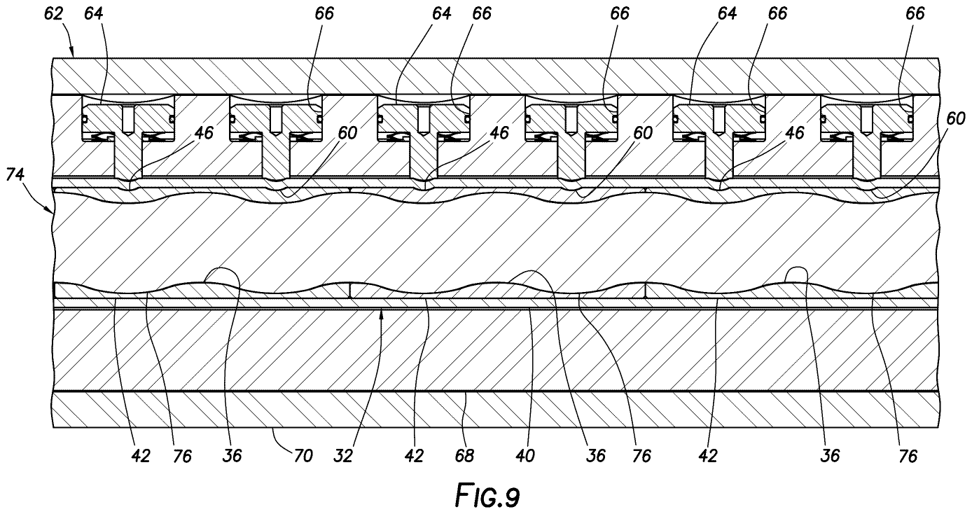

Referring additionally now to FIG. 9, a cross-sectional view of another example of the protrusions 60 being formed in the housing 40 of the stator 32 is representatively illustrated. In this example, an alignment mandrel 74 is used to rotationally index and align the stator sections 42 relative to each other.

The alignment mandrel 74 has external helical lobes 76 formed thereon. The lobes 76 are complementary to the lobes 36 of the stator sections 42. When the stator sections 42 are positioned end-to-end on the alignment mandrel 74, the stator sections are rotationally indexed and aligned with each other, so that the lobes 36 extend continuously through the stator sections.

The stator sections 42 may be positioned on the alignment mandrel 74 before or after the stator sections are installed in the housing 40. The stator sections 42 are positioned on the alignment mandrel 74 and installed in the housing 40 prior to deforming the protrusions 60 into the recesses 46, in the FIG. 9 example.

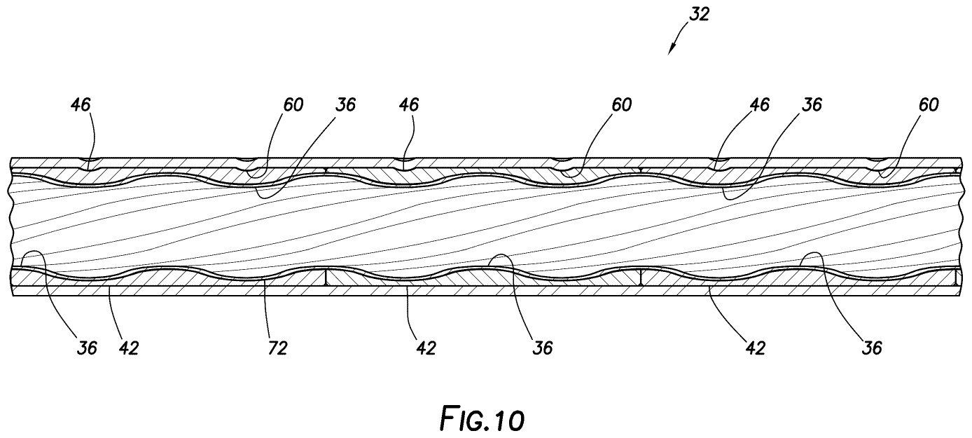

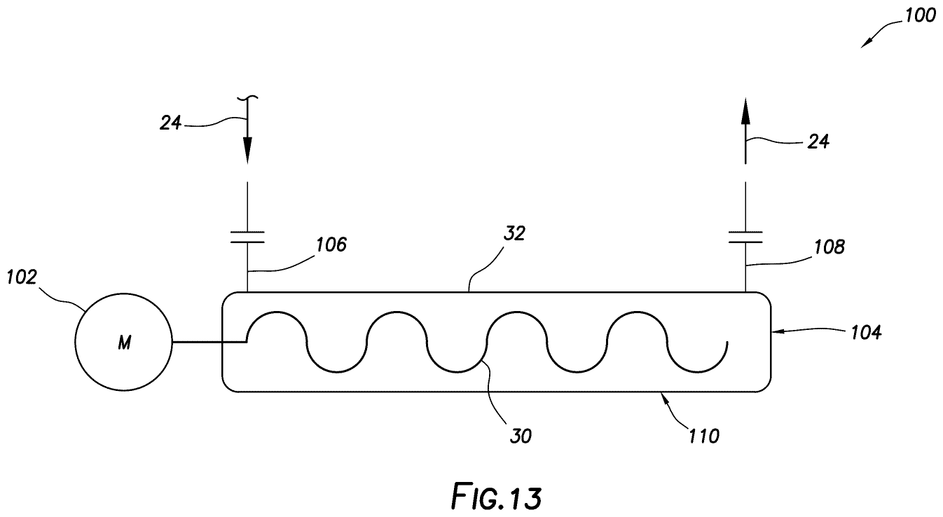

Referring additionally now to FIG. 10, a cross-sectional view of another example of the stator 32 is representatively illustrated. In the FIG. 10 example, a coating or lining 72 is provided in the stator sections 42. The lining 72 is attached to the interior surfaces of the stator sections 42, so that the lining forms an interior layer of the lobes 36. The lining 72 can be selected to enhance sealing between the exterior and interior lobes 34, 36 of the rotor 30 and stator 32, to extend a useful life of the fluid motor 22 (or fluid pump 104, see FIG. 13), to reduce friction, to increase output or efficiency, or for any other beneficial purpose.

The lining 72 may comprise a suitable material selected to achieve one or more purpose or function. For example, the material could comprise an elastomer (such as, rubber, etc.), a relatively ductile but tough material (such as, a metal), a wear resistant material, a relatively low coefficient of friction material, etc. The scope of this disclosure is not limited to any particular material used for the lining 72.

The lining 72 may be installed or attached using any suitable technique. For example, the lining 72 may be molded, deposited, adhered, sprayed, bonded, accumulated or otherwise applied on the interior surfaces of the stator sections 42, preferably after the stator sections have been rotationally indexed and aligned with each other. The stator sections 42 may or may not be secured in the housing 40 when the lining 72 is applied on the interior surfaces of the stator sections.

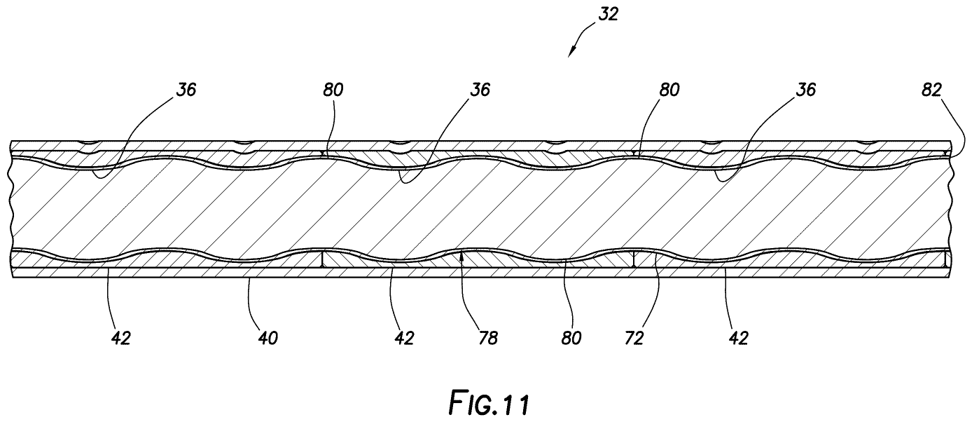

Referring additionally now to FIG. 11, a cross-sectional view of an example of the lining 72 being installed in the stator sections 42 is representatively illustrated. In this example, the lining 72 is formed by injecting a material 82 between the stator sections 42 and an externally profiled mandrel 78 installed in the stator sections.

The mandrel 78 may be similar in many respects to the FIG. 9 alignment mandrel 74. However, the mandrel 78 is dimensioned to provide a suitably thick gap between the mandrel and the stator sections 42, so that the material 82 can be injected into the gap. After the material 82 has cured, hardened, etc., the mandrel 78 can be removed from the stator sections 42.

As depicted in FIG. 11, the mandrel 78 has external helical lobes 80 formed thereon which are complementary to, but spaced apart somewhat from, the internal lobes 36 of the stator sections 42. The spacing or gap between the lobes 36, 80 may be consistent along the axial length of the stator 32, or there may be variations in the thickness of the material 82. The scope of this disclosure is not limited to any particular shape or configuration of the lining 72.

The mandrel 78 and lining 72 may serve to rotationally index and align the stator sections 42 relative to each other while the stator sections are being secured in the housing 40 (e.g., while the housing 40 is being deformed as depicted in FIGS. 8 & 9, or while a material 98 is being injected between the housing and the stator sections, etc.). Alternatively, the mandrel 78 and lining 72 may be installed after the stator sections 42 are secured in the housing 40. The scope of this disclosure is not limited to any particular order of steps (e.g., installing the stator sections 42 in the housing 40, securing the stator sections in the housing, rotationally indexing and aligning the stator sections, installing the mandrel 78, injecting the material 82, etc.).

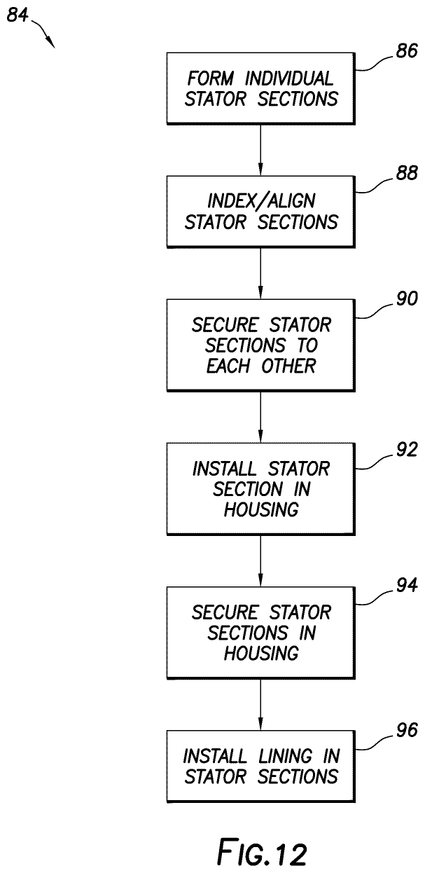

Referring additionally now to FIG. 12, a flowchart for an example method 84 of producing the fluid motor 22 (or the fluid pump 104) is representatively illustrated. However, the method 84 may be used to produce other fluid motors or fluid pumps in keeping with the scope of this disclosure. Although a particular order of steps is depicted in FIG. 12, the scope of this disclosure is not limited to any particular order, number or combination of steps as depicted in FIG. 12 or described herein.

In an initial step 86 depicted in FIG. 12, multiple separate, individual stator sections 42 are formed. The stator sections 42 have internal helical lobes 36 formed therein. Any technique (such as, casting, molding, electrical discharge machining, three-dimensional printing, powder metallurgy, etc.) may be used for forming the stator sections 42 and the lobes 36 therein.

In step 88, the stator sections 42 are rotationally indexed and aligned with each other. Adjacent pairs of the stator sections 42 are rotationally indexed, so that the lobes 36 extend continuously from one stator section to the next.

Various techniques may be used for rotationally indexing and aligning the stator sections 42. Examples include (but are not limited to) positioning the stator sections 42 on the alignment mandrel 74, engaging devices 54, 56, 58 on ends 50, 52 of the stator sections, etc. In one example, helical grooves could be formed on exterior surfaces of the stator sections 42, and a helical member could be installed in the aligned grooves to maintain the rotational alignment of the stator sections.

In step 90, the stator sections 42 are secured to each other. Adjacent pairs of the stator sections 42 may be secured directly to each other (such as, by welding, bonding, etc.), or an additional component (such as, the housing 40) may be used to indirectly secure the stator sections relative to each other.

In step 92, the stator sections 42 are installed in the housing 40. In different examples, the stator sections 42 may be installed in the housing 40 before or after the stator sections are secured to each other.

In one example, a material 98 (such as, an elastomer, a bonding agent, an adhesive, etc.) is injected between the stator sections 42 and the housing 40 after the stator sections are installed in the housing. In another example, the housing 40 is deformed to secure the stator sections 42 in the housing, and to secure the stator sections relative to each other, after the stator sections are installed in the housing. In yet another example, welds are formed through openings in a wall of the housing 40 to thereby to secure the stator sections 42 in the housing, and to secure the stator sections relative to each other, after the stator sections are installed in the housing.

In step 94, the stator sections 42 are secured in the housing 40. In some examples, securing the stator sections 42 in the housing 40 also serves to secure the stator sections to each other.

In various examples described above, the stator sections 42 can be secured in the housing 40 by deforming the housing (such as, forming the protrusions 60 that extend into the recesses 46 on the stator sections), welding the stator sections to the housing (such as, via holes in the housing wall), or injecting a material 98 (such as, an elastomer, a bonding agent, an adhesive, etc.) between the housing and the stator sections. However, the scope of this disclosure is not limited to any particular technique used to secure the stator sections 42 to each other, or to the housing 40.

In step 96, a lining 72 can be provided in the stator sections 42, for example, if metal-to-metal contact is not desired between the rotor 30 and stator 32. The lining 72 may be installed in the stator sections 42 at various points in the method 84. Thus, it is not necessary for the lining 72 to be installed after the stator sections 42 are secured in the housing 40.

Various techniques may be used to install the lining 72 in the stator sections 42. For example, the lining 72 may be applied to the interior surfaces of the stator sections 42 by molding, spraying, depositing, three-dimensional printing, bonding, coating, etc. If molding is selected, an externally profiled mandrel 78 (e.g., having complementary external lobes 80) may be inserted into the stator sections 42, and then a material 82 injected into a gap between the mandrel 78 and the stator sections.

In some examples, the lining 72 could be produced separate from the stator sections 42. The lining 72 could initially be in the shape of a tube, for example. The lining 72 could be inserted into the stator sections 42 and bonded to the interior surfaces of the stator sections. Thus, the scope of this disclosure is not limited to any particular technique for installing the lining 72 in the stator sections 42.

Although the above description of the rotor 30 and the stator 32 relate primarily to their use in a fluid motor, it will be appreciated by those skilled in the art that a fluid pump can also comprise a similarly constructed rotor and stator. For example, a progressive cavity fluid pump can comprise the rotor 30 and the stator 32 with one or multiple stator sections 42. In this example, the rotor 30 can be rotated by a motor (such as, an electric, hydraulic, or other type of motor) to thereby pump the fluid 24. Thus, any type of progressive cavity assembly can benefit from the principles of this disclosure.

Referring additionally now to FIG. 13, an example of a fluid pump assembly 100 is representatively and schematically illustrated. In this example, the pump assembly 100 includes a motor 102 and a progressive cavity fluid pump 104 for producing the fluid flow 24.

The fluid pump 104 includes the rotor 30 and the stator 32. The rotor 30 in this example is suitably configured for connection to the motor 102 (such as, with a flexible shaft, a constant velocity or universal joint, etc.), so that the rotor can be rotated by the motor. Rotation of the rotor 30 in the stator 32 causes the fluid 24 to flow from an inlet 106 to an outlet 108 of the fluid pump 104. Rotation of the rotor 30 in the stator 32 in an opposite direction will cause the fluid 24 to flow from the outlet 108 to the inlet 106.

The fluid pump 104 comprises another example of the progressive cavity assembly 110. In this example, the fluid pump 104 is a Moineau-type positive displacement or progressive cavity pump. The assembly 110 comprises the rotor 30 and stator 32.

The motor 102 may be any type of motor suitable for rotating the rotor 30 in the stator 32. For example, the motor 102 could be an electric, hydraulic, or other type of motor. In some examples, means other than a motor may be used to rotate the rotor 30.

The fluid pump assembly 100 may be used in well operations (such as, to produce the fluid flow 24 through the tubular string 12 in the FIG. 1 system 10 and method). Alternatively, the fluid pump assembly 100 may be used in other types of operations (such as, operations in commercial, industrial, manufacturing, governmental, military, agricultural or other activities). The scope of this disclosure is not limited to any particular use of the fluid pump assembly 100.

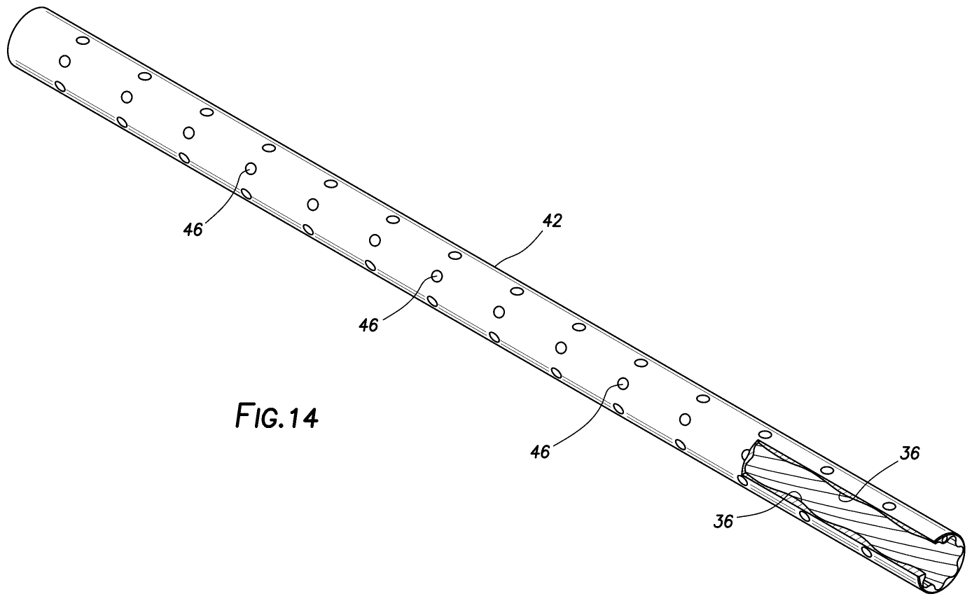

Referring additionally now to FIG. 14, a representative perspective and partially cross-sectional view of another example of the stator section 42 is depicted. The FIG. 14 stator section 42 may be used with any of the stator 32 examples and in any of the progressive cavity assembly 110 examples described herein, or it may be used with other stators or progressive cavity assemblies.

In the FIG. 14 example, only a single stator section 42 is used to provide a desired full internal helical profile (comprising the lobes 36) for an assembly 110. There may be any fraction or multiple of full stages formed in the stator section 42.

The FIG. 14 stator section 42 may be lined with the lining 72, and the material 98 may be used between the stator section and the outer housing 40 to secure the stator section therein (see FIG. 8). The stator section 42 may be provided with the recesses 46 for receiving the protrusions 60 to secure the stator section 42 in the housing 40.

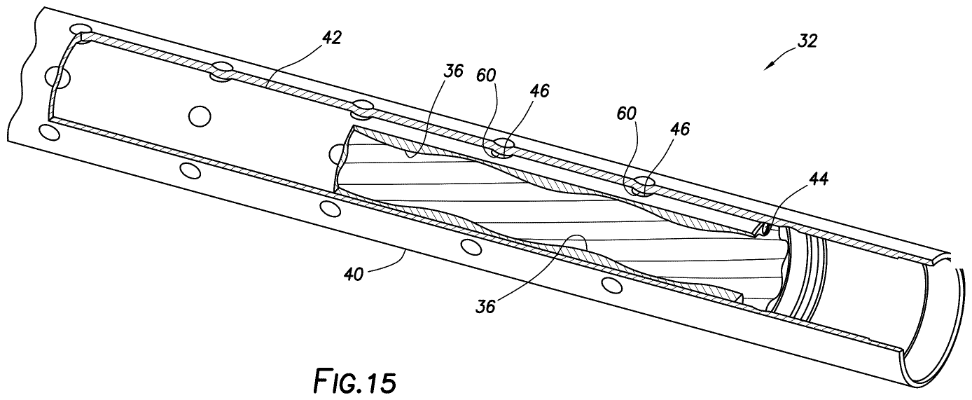

Referring additionally now to FIG. 15, a representative perspective and partially cross-sectional view of another example of the stator 32 is depicted. In this view, the FIG. 14 single piece stator section 42 is secured in the outer housing 40.

In the FIG. 15 example, the stator section 42 is secured in the outer housing 40 by deforming the outer housing. The protrusions 60 are formed, so that they extend into the respective recesses 46 on the stator section 42 (as in the FIGS. 7-11 examples). In various examples, the stator section 42 may be lined with the lining 72, and the material 98 may be used between the stator section and the outer housing 40 to secure and seal the stator section therein. The stator section 42 may be press-fit or shrink-fit in the outer housing 40. The scope of this disclosure is not limited to any particular technique for securing the stator section 42 in the outer housing 40.

The stator section 42 may be heat treated or a wear resistant treatment, layer or coating may be applied to the stator section before it is installed and secured in the outer housing 40. The stator section 42 may be made of a harder or more wear resistant material than the outer housing 40, and/or the outer housing may be made of a tougher or more ductile material than the stator section.

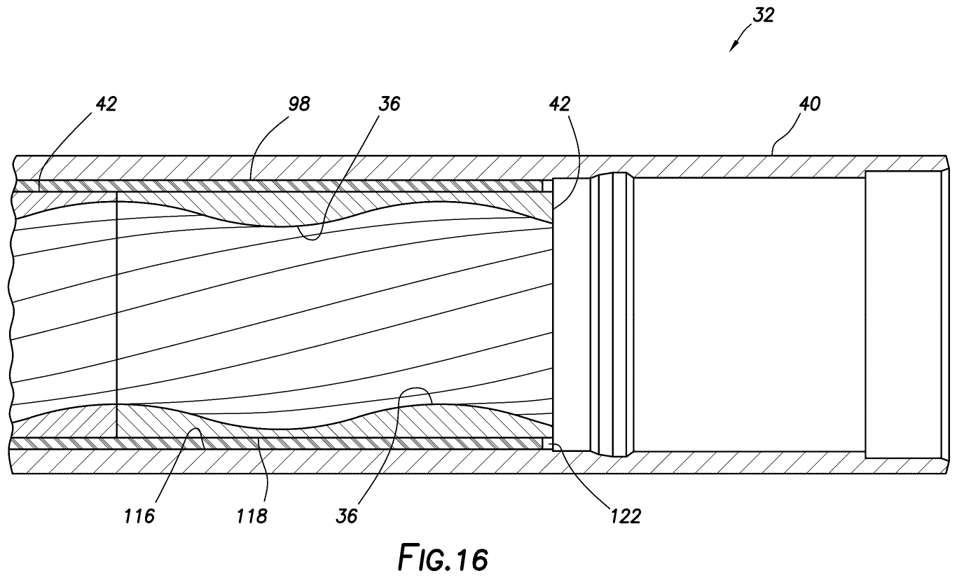

Referring additionally now to FIG. 16, a representative cross-sectional view of another example of the stator 32 is depicted. The FIG. 16 stator 32 may be used with a rotor 30 in any of the progressive cavity assemblies 110 disclosed herein.

In the FIG. 16 example, the stator 32 includes multiple stator sections 42 secured in the outer housing 40. In other examples, only a single stator section 42 may be secured in the outer housing 40.

The stator sections 42 are rotationally aligned with each other (for example, using the alignment mandrel 74) and then the material 98 is injected into a radial gap 122 between an interior surface 116 in the housing 40 and an exterior surface 118 on the stator section 42. The alignment mandrel 74 may centralize the stator section 42 in the outer housing 40. When the material 98 cures or hardens, the stator sections 42 are secured against rotational and axial movement in the outer housing 40.

The material 98 in this example may comprise elastomers, glues, epoxies, molten metal, plastics or other suitable material. The surfaces 116, 118 may be coated with a primer and adhesive prior to injection of the material 98 to improve bonding between the surfaces and the material. Surface treatments (such as, roughening, knurling, abrading, etc.) may be applied to the surfaces 116, 118 to increase friction between the surfaces and the material 98. Pressure and/or temperature treatments can be applied after injection to cure or harden the material 98.

A lining 72 may be installed or formed in the stator sections 42 if desired. The lining 72 may be installed or formed at the same time as, or after, injection of the material 98.

Note that no recesses 46 are formed in the exterior surface 118, and no protrusions 60 extend inward from the interior surface 116 in the FIG. 16 example. Instead, the stator section 42 is secured in the housing 40 solely by the material 98.

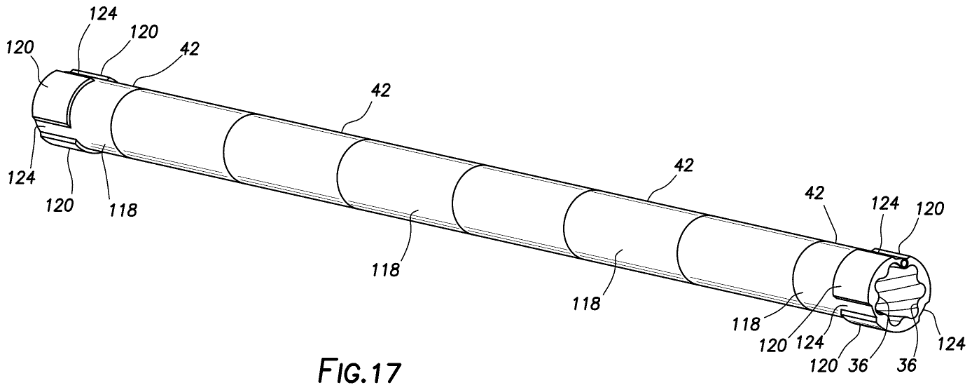

Referring additionally now to FIGS. 17 & 18, representative perspective views of an example of a stator section assembly or stack is depicted. The FIGS. 17 & 18 stator section assembly includes multiple stator sections 42. In other examples, only a single stator section 42 may be used. The FIGS. 17 & 18 stack of stator sections 42 may be used in any of the stators 32 disclosed herein.

As depicted in FIGS. 17 & 18, stator sections 42 at opposite ends of the stack have centralizer surfaces 120 formed thereon. The centralizer surfaces 120 extend radially outward relative to the exterior surface 118.

In some examples, the end stator sections 42 can be press-fit or shrink-fit in the outer housing 40. The centralizer surfaces 120 may be interference fit in the interior surface 116 of the housing 40.

In the FIGS. 17 & 18 example, there are three of the centralizer surfaces 120 on each of the end stator sections 42, with a circumferential gap 124 between each adjacent pair of the centralizer surfaces. When injecting the material 98 between the interior and exterior surfaces 116, 118 (as in the FIG. 16 example), the material can be conveniently flowed through the gaps 124.

The alignment mandrel 74 may be installed in the stack of stator sections 42 during the injection process to centralize the stator sections in the housing 40 and rotationally align the stator sections with each other.

A lining 72 may be installed or formed in the stator sections 42 if desired. The lining 72 may be installed or formed at the same time as, or after, injection of the material 98.

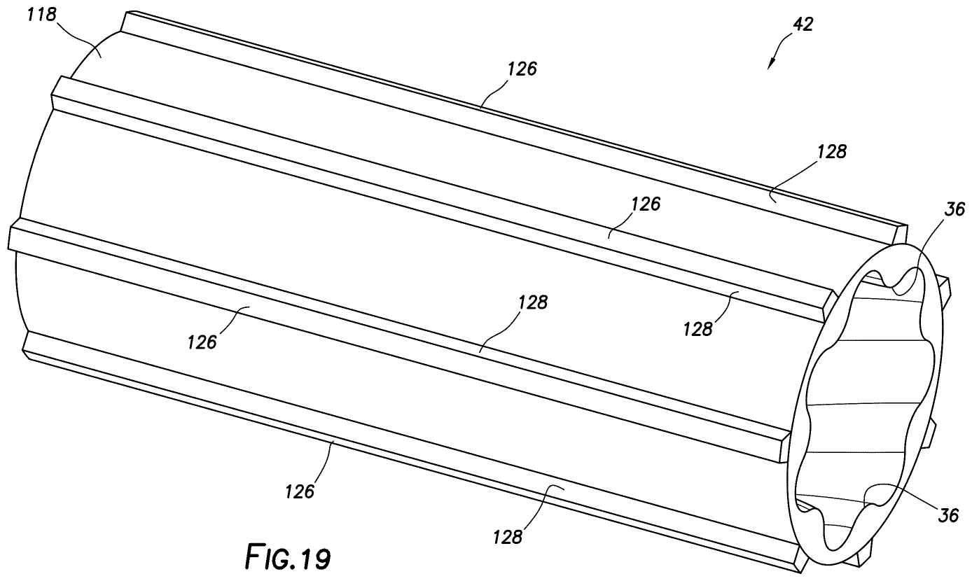

Referring additionally now to FIG. 19, a representative perspective view of another example stator section 42 is representatively illustrated. The FIG. 19 stator section 42 may be used for any of the other stator sections in any of the stators 32 disclosed herein.

As depicted in FIG. 19, multiple axially extending ribs 126 are formed on the exterior surface 118. Any number of ribs 126 may be used. The ribs 126 in various examples could have different shapes (such as, helical, zig-zag, curved, etc.). Thus, the scope of this disclosure is not limited to any particular number, configuration or shape of the ribs 126.

The ribs 126 can serve to centralize the stator section 42 in the outer housing 40. In some examples, the ribs 126 may be interference fit in the interior surface 116 of the housing 40. For example, the stator section 42 may be press-fit or shrink-fit in the housing 40.

Each of the ribs 126 has opposing faces 128 formed on respective opposite sides of the ribs. When the material 98 is injected between the interior and exterior surfaces 116, 118, the material can flow between the faces 128.

After the material 98 has cured or hardened, the faces 128 will abut the material and prevent rotation of the stator section 42 relative to the material (and the housing 40).

A lining 72 may be installed or formed in the stator sections 42 if desired. The lining 72 may be installed or formed at the same time as, or after, injection of the material 98.

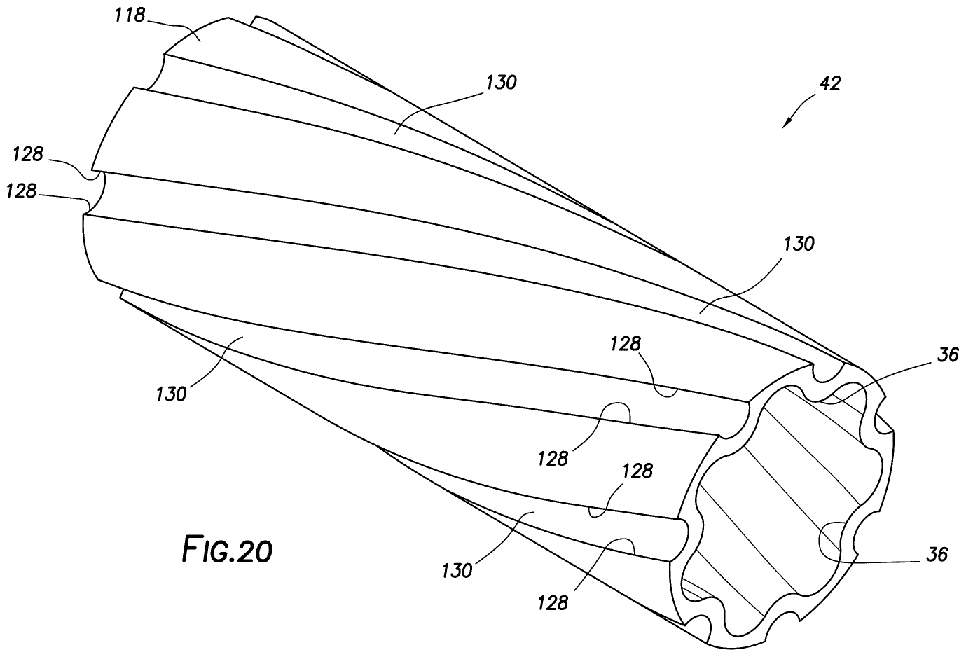

Referring additionally now to FIG. 20, a representative perspective view of another example stator section 42 is depicted. The stator section 42 may be used for any of the other stator sections and in any of the stators 32 disclosed herein.

In the FIG. 20 example, multiple helical grooves 130 are formed in the exterior surface 118 of the stator section 42. The opposing faces 128 are formed on respective opposite sides of the grooves 130. Any number of grooves 130 may be formed in the exterior surface 118 in other examples.

As depicted in FIG. 20, each of the grooves 130 overlies one of the internal lobes 36. In this manner, the grooves 130 are formed in the otherwise thickest wall portions of the stator section 42.

When the material 98 is injected between the interior and exterior surfaces 116, 118, the material can flow between the faces 128 of the grooves 130. After the material 98 has cured or hardened, the faces 128 will abut the material and prevent rotation of the stator section 42 relative to the material (and the housing 40).

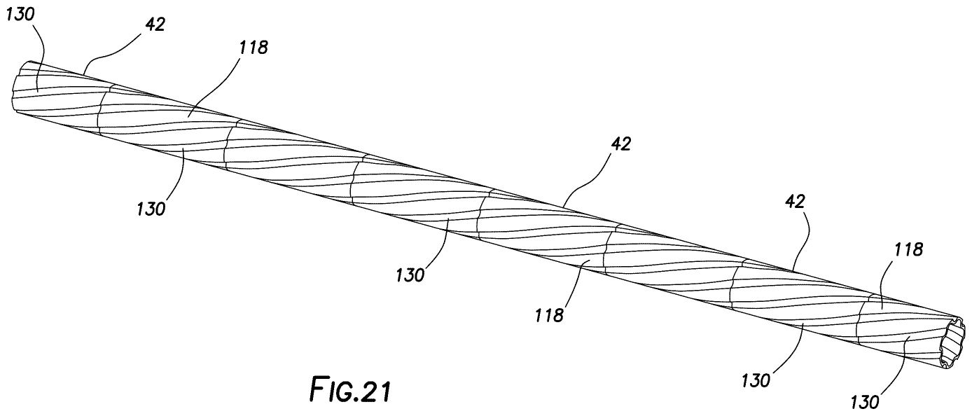

Referring additionally now to FIG. 21, a representative perspective view of an assembly of the FIG. 20 stator sections 42 is depicted. In this view, it may be seen that the grooves 130 on each of the stator sections 42 are rotationally aligned with the grooves of adjacent stator section(s). Thus, the injected material 98 can flow through the aligned grooves 130 along the entire length of the stack of stator sections. The stator sections 42 may be rotationally aligned and centralized using the alignment mandrel 74.

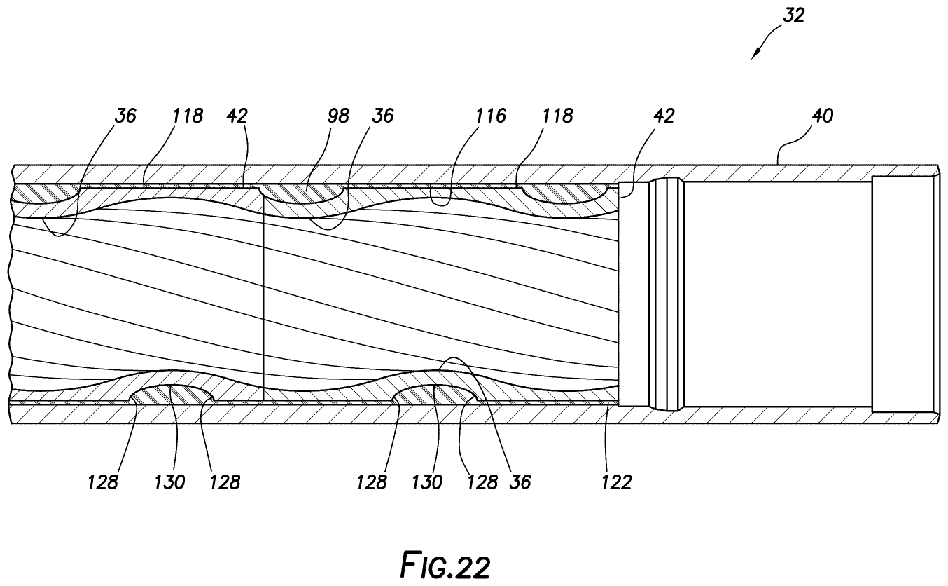

Referring additionally now to FIG. 22, a representative cross-sectional view of an example of the stator 32 comprising the FIG. 21 stator section 42 assembly is depicted. In this view, the stator sections 42 have been rotationally aligned with each other (for example, using the alignment mandrel 74) and centralized in the housing 40.

The material 98 is then injected into the gap 122 between the interior and exterior surfaces 116, 118, and through the grooves 130. After the material 98 has cured or hardened, the faces 128 will abut the material and prevent rotation of the stator sections 42 relative to the material (and the housing 40).

In some examples (such as, if the stator sections 42 are interference fit in the outer housing 40), there may be no gap 122 between the interior and exterior surfaces 116, 118. In these examples, the material 98 may be injected into the grooves 130 without also being injected into the gap 122.

Any of the stator sections 42 described herein may be used in place of the stator sections depicted in FIG. 22. A single stator section 42 or multiple stator sections may be secured in the housing 40 with the material 98.

A lining 72 may be installed or formed in the stator section(s) 42 if desired. The lining 72 may be installed or formed at the same time as, or after, injection of the material 98.

In any of the stators 32, rotors 30, assemblies 110 and methods described herein, various combinations of materials, material grades, coatings or surface treatments may be used which best suit a particular application. For example, the outer housing 40 can be manufactured from ductile, fatigue resistant, high-strength materials that are best suited for supporting an external load applied to the outer housing, while the material used for manufacturing the stator section(s) 42 can be very hard, and potentially brittle, but suitable for high wear applications, even if it is unsuitable for use as an external structural component.

In any of the examples described herein, the stator sections 42 may be lined with the lining 72, and the material 98 may be used between the stator sections and the outer housing 40 to secure or seal the stator sections therein. The stator sections 42 may be heat treated or a wear resistant treatment, layer or coating may be applied to the stator sections before they are installed and possibly interference fit in the outer housing 40. The stator sections 42 may be made of a harder or more wear resistant material than the outer housing 40, and/or the outer housing may be made of a tougher or more ductile material than the stator sections.

Many steel and exotic alloys which are excellent for wear and durability are very difficult or impossible to weld. Examples include 440C stainless steel in a high-hardness condition, copper/nickel/tin alloys such as ToughMet(TM), tool steels, etc.

Beneficially, the stator 32 designs described herein can be constructed using non-weldable materials of almost any type. Additionally, the construction methods described herein can be used to make extremely durable stators 32 by using a suitable outer housing 40 material in combination with non-metallic materials such as tungsten carbide alloys, ceramics, etc., in the stator section(s) 42. In addition, combinations of materials can be used by selecting two or more different materials for respective two or more stator sections 42.

Another potential advantage of the stator 32 designs described herein is the ability to heat-treat or apply surface treatments (such as, wear resistant treatments) to the stator section(s) 42 prior to and independent from the outer housing 40 prior to installation of the stator section(s) in the outer housing. Many heat-treating processes and surface treatments (such as nitriding, boronizing, titanium nitriding, carburizing, etc.) are more effectively applied to relatively small, short components.

The present disclosure provides to the art a progressive cavity assembly 110. In one example, one or more stator section(s) 42 can be secured in an outer housing 40, with a material 98 injected between the stator section(s) and the outer housing to secure the stator sections in the housing.

The present disclosure provides to the art a progressive cavity assembly 110. In one example, the progressive cavity assembly 110 may include a rotor 30 and a stator 32 surrounding the rotor 30. The stator 32 can comprise a tubular housing 40 and a stator section 42 having a helical stator profile (e.g., comprising the lobes 36) formed therein. A material 98 between the stator section 42 and the housing 40 secures the stator section 42 in the housing 40, and the material 98 abuts a face 128 of the stator section 42 configured to prevent rotation of the stator section 42 relative to the material 98.

The stator 32 may include a plurality of the stator sections 42, and the material 98 may prevent relative rotation between the stator sections 42. The face 128 may be formed on a groove 130 in an exterior surface 118 of the stator section 42.

The groove 130 may extend helically in the exterior surface 118. The groove 130 may overlie a helical lobe 36 formed in the stator section 42.

The face 128 may be formed on a gap 124 between centralizer surfaces 120 on the stator section 42. There may be an interference fit between the housing 40 and the centralizer surfaces 120.

The face 128 may be formed on a rib 126 that extends outward from an exterior surface 118 of the stator section 42. The rib 126 may extend axially on the exterior surface 118. There may be an interference fit between the housing 40 and the rib 126.

There may be metal-to-metal contact between the rotor 30 and the stator 32. In some examples, a lining 72 may be provided in the stator section(s) 42.

The present disclosure also provides to the art a method of producing a progressive cavity assembly 110. In one example, the method can comprise:
providing a stator section 42 having a helical stator profile formed therein;
positioning the stator section 42 in a tubular housing 40, the positioning step including centralizing the stator section 42 in the housing 40; and injecting a material 98 into a gap 122 between an interior surface 116 of the housing 40 and an exterior surface 118 of the stator section 42, thereby securing the stator section 42 in the housing 40.

The securing step may include the material 98 curing between the interior surface 116 and the exterior surface 118.

The injecting step may include flowing the material 98 into a groove 130 formed in the exterior surface 118. The method may include helically forming the groove 130 in the exterior surface 118. The method may include forming the groove 130 in the exterior surface 118 so that it overlies a helical lobe 36 formed in the stator section 42.

The centralizing step may include interference fitting in the housing 40 centralizer surfaces 120 extending outward relative to the exterior surface 118. The injecting step may include injecting the material 98 into a gap 124 formed between the centralizer surfaces 120.

The centralizing step may include engaging multiple ribs 126 formed on the exterior surface 118 with the interior surface 116. The centralizing step may further include interference fitting the ribs 126 in the housing 40. The injecting step may include flowing the material 98 between the ribs 126.

The injecting step may include contacting the material 98 with a face 128 formed on the exterior surface 118. The face 128 is configured to prevent rotation of the stator section 42 relative to the material 98.

The method may include forming the face 128 on a groove 130 in the exterior surface 118. The method may include forming the face 128 on a rib 126 on the exterior surface 118.

The method may include inserting a rotor 30 into the stator 32, thereby causing metal-to-metal contact between the rotor 30 and the stator 32.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A progressive cavity assembly, comprising:
a rotor; and
a stator surrounding the rotor, the stator comprising:
a tubular housing; and
a stator section having a helical stator profile formed therein,
in which a material between the stator section and the housing secures the stator section in the housing, and the material abuts a face of the stator section configured to prevent rotation of the stator section relative to the material.

2. The progressive cavity assembly of claim 1, in which the stator further comprises a plurality of the stator sections, and the material prevents relative rotation between the stator sections.

3. The progressive cavity assembly of claim 1, in which the face is formed on a groove in an exterior surface of the stator section.

4. The progressive cavity assembly of claim 3, in which the groove extends helically in the exterior surface.

5. The progressive cavity assembly of claim 4, in which the groove overlies a helical lobe formed in the stator section.

6. The progressive cavity assembly of claim 1, in which the face is formed on a gap between centralizer surfaces on the stator section.

7. The progressive cavity assembly of claim 6, in which there is an interference fit between the housing and the centralizer surfaces.

8. The progressive cavity assembly of claim 1, in which the face is formed on a rib that extends outward from an exterior surface of the stator section.

9. The progressive cavity assembly of claim 8, in which the rib extends axially on the exterior surface.

10. The progressive cavity assembly of claim 8, in which there is an interference fit between the housing and the rib.

11. The progressive cavity assembly of claim 1, in which there is metal-to-metal contact between the rotor and the stator.

12. A method of producing a progressive cavity assembly, the method comprising:
providing a stator section having a helical stator profile formed therein;
positioning the stator section in a tubular housing, the positioning comprising centralizing the stator section in the housing; and
injecting a material into a gap between an interior surface of the housing and an exterior surface of the stator section, thereby securing the stator section in the housing.

13. The method of claim 12, in which the securing comprises the material curing between the interior surface and the exterior surface.

14. The method of claim 12, in which the injecting comprises flowing the material into a groove formed in the exterior surface.

15. The method of claim 14, further comprising helically forming the groove in the exterior surface.

16. The method of claim 14, further comprising forming the groove in the exterior surface so that it overlies a helical lobe formed in the stator section.

17. The method of claim 12, in which the centralizing comprises interference fitting in the housing centralizer surfaces extending outward relative to the exterior surface.

18. The method of claim 17, in which the injecting comprises injecting the material into a gap formed between the centralizer surfaces.

19. The method of claim 12, in which the centralizing comprises engaging multiple ribs formed on the exterior surface with the interior surface.

20. The method of claim 19, in which the centralizing further comprises interference fitting the ribs in the housing.

21. The method of claim 19, in which the injecting comprises flowing the material between the ribs.

22. The method of claim 12, in which the injecting comprises contacting the material with a face formed on the exterior surface, the face being configured to prevent rotation of the stator section relative to the material.

23. The method of claim 22, further comprising forming the face on a groove in the exterior surface.

24. The method of claim 22, further comprising forming the face on a rib on the exterior surface.

25. The method of claim 12, further comprising inserting a rotor into the stator, thereby causing metal-to-metal contact between the rotor and the stator.
